(19) United States
(12) Patent Application Publication
(10) Pub. No.: US 2009/0047400 A1
(43) Pub. Date: Feb. 19, 2009

(54) APPARATUS AND METHOD FOR HYBRID INFUSION OF FOOD PIECES

(76) Inventors: Varadharajan Radhami Basker, Plano, TX (US); Phillip Stuart Frazier, Frisco, TX (US); Vamshidhar Puppala, McKinney, TX (US); V. N. Rao, Plano, TX (US)

Correspondence Address: CARSTENS & CAHOON, LLP, P O BOX 802334, DALLAS, TX, 75380, US

(21) Appl. No.: 11/839,696

(22) Filed: Aug. 16, 2007

(51) Int. Cl. A23L 1/212

(52) U.S. Cl. 426/335; 426/442; 426/615; 99/468; 99/472; 99/486; 99/516

(57) ABSTRACT

The present invention provides a method and an apparatus for the hybrid infusion of solutes, which comprises atmospheric infusion followed by vacuum infusion, into food pieces within a single apparatus. The apparatus comprises an internal conveyor for holding a bed of product to be infused, two retaining walls extending the length of the internal conveyor to contain the bed of product, a mixing mechanism that moves upward and downward at a predetermined velocity and periodicity to immerse floating product and gently mix, and a vacuum port for depressurizing the apparatus for predetermined periods of time during infusion and draining of the infusion solution.

### BACKGROUND OF THE INVENTION

1. Technical Field

The present invention relates to an apparatus and a method for the infusion of solutes into food pieces. More specifically, the invention relates to an apparatus and a method for the infusion of food pieces, particularly fruit and vegetable pieces, by hybrid infusion, comprising atmospheric infusion followed by vacuum infusion within a single apparatus.

2. Description of Related Art

In recent years, consumer demand has been dramatically increasing for healthy foods in general, and healthy snack foods in particular. Healthy snack foods generally take the form of dehydrated slices or cubes of whole fruits or vegetables. The fruit and vegetable pieces (“pieces”) are typically dehydrated via vacuum frying as conventional frying yields snacks with an undesirable appearance and higher oil content than desired.

Infusion of the fruit and vegetable pieces prior to frying is essential to the dehydration process to achieve the desired product characteristics. Dehydration without prior infusion results in shrinkage of the pieces and an unacceptable texture for sale to consumers. These issues may be resolved by infusing the fruit and vegetable pieces prior to dehydration. Infusion of the fruit and vegetable pieces with a solution containing mono-, di-, or oligo-saccharides, fruit juices, or vegetable fibers adds solids to the fruit and vegetable pieces, which builds the body structure of the pieces and prevents collapse during dehydration. The resulting product is crunchy, has acceptable oil content and retains the appearance of the original fruit and vegetable pieces.

Well known methods exist in the art for infusion of fruit and vegetable pieces. One such method is the continuous or step-wise infusion at atmospheric pressure. Under this method, disclosed in U.S. Pat. No. 5,718,939 to Nugent and U.S. Pat. No. 6,440,483 to Ghaedian et al., fruit and vegetable pieces are treated with water or an aqueous solution to rapture the pieces' cell walls, then with an infusion solution to infuse the pieces with solids. These steps may be performed continuously in a single apparatus or step-wise in a series of apparatuses.

Another well known method in the art is vacuum infusion, disclosed in U.S. Pat. No. 5,747,088 to Fletcher, where the fruit and vegetable pieces are subjected to decreased pressure (less than atmospheric pressure) while in an infusion solution. This method accelerates the mass transfer of solids and water in the pieces and significantly reduces the time required for infusion compared to atmospheric infusion. Vacuum infusion employs two mechanisms—osmotic dehydration followed by infusion of solids. Osmotic dehydration, the evacuation of water and gas from the fruit and vegetable pieces, occurs when the vacuum is first applied and the apparatus is depressurized. When the vacuum is released and the apparatus repressurizes, solids from the infusion solution are taken in by the pieces to fill the spaces left by the evacuated water and gas.

However, applying a vacuum immediately after contact between the fruit and vegetable pieces and the infusion solution damages the cell walls of the product, leading to increased oil absorption during further operations. Thus, it is preferred to subject the fruit and vegetable pieces to reduced pressure after a period of atmospheric infusion to allow the pieces to build structure and prevent damage to the pieces' cell walls when the vacuum is applied. Current technology utilizes either atmospheric or vacuum infusion, but not both methods in conjunction, which would maximize the efficiency of the infusion process. It is desirable to be able to conduct both infusion methods, either in conjunction or alone, within a single apparatus and customize the times to be used for each method and pressure levels for the vacuum infusion period to achieve the desired product characteristics.

Another drawback of current technology for infusion of fruit and vegetable pieces lies in the lack of uniform infusion of all pieces. Most fruit and vegetable pieces float in solution rather than remaining completely submerged in the solution throughout the infusion process. A means for immersing the fruit and vegetable pieces and gently mixing the pieces in the solution is desired to obtain sufficient contact between the pieces and the infusion solution.

Collection issues also arise due to the fruit and vegetable pieces floating in the infusion solution. Current technology uses rotating or vertically standing drums, as disclosed in U.S. Pat. No. 6,457,403 to Wettlaufer et al., U.S. Pat. No. 6,159,527 to Wettlaufer, U.S. Pat. No. 6,479,092 to Wettlaufer, and U.S. Pat. No. 6,440,483 to Ghaedian et al., in which collection is difficult and requires manual intervention, thereby reducing efficiency and increasing time between batches. An apparatus that allows for the collection of the pieces without manual intervention is desired.

Downstream operations are affected by residual infusion solution on the fruit and vegetable pieces after removal from the infusion process. Excess sugar or solutes, still on the pieces from the infusion process, causes sugar buildup in the downstream operations and a resulting infusion solution waste and yield loss. Current technology washes the fruit and vegetable pieces after removal from the infusion solution to reduce sugar buildup downstream, but it would be preferred to eliminate the additional step and accomplish removal of the residual infusion solution as the product is removed from the infusion solution.

Further, some fruit and vegetable pieces are individually quick frozen prior to infusion. Infusion cannot take place when the pieces are frozen. Thus, fruit and vegetable pieces that are individually quick frozen must be tempered, requiring an additional step before infusion may occur. It is desired to combine the steps of tempering and infusion into a single step within an apparatus to decrease the overall time required for the infusion process.

### SUMMARY OF THE INVENTION

The present invention provides a method and an apparatus for the hybrid infusion of solutes into food pieces, which comprises atmospheric infusion followed by vacuum infusion, within a single apparatus. The pieces are introduced into the apparatus, where they undergo a period of atmospheric infusion to build the pieces' body structures and then a period of vacuum infusion to accelerate the infusion process and decrease the overall time needed for infusion. The time for each phase and level of the pressure during the vacuum phase may be adjusted for a chosen fruit or vegetable to achieve the desired product characteristics.

In one aspect, the apparatus of the present invention comprises a sealable vessel containing a mixing mechanism that provides a means for immersing and gently mixing the pieces while in solution. The mixing mechanism moves upward and downward at a predetermined velocity and periodicity, customized for the specific inputted food piece, to immerse the pieces in solution to ensure sufficient contact for uniform infusion.

In one aspect, the apparatus of the present invention further comprises retaining walls extending the length of, and abutting the longitudinal sides of, an internal conveyor to prevent floating pieces from straying away from directly above the internal conveyor. Alternative embodiments of the invention allow for the side walls of the apparatus to act as retaining walls. As the infusion solution is drained from the apparatus, the retaining walls, along with gravity, ensures that the pieces settle on the internal conveyor for collection, regardless of whether the pieces are completely immersed in the solution or floating in the solution. The internal conveyor then delivers the infused pieces for further operations, removing the need for manual intervention during the collection process.

In one aspect, the method of the present invention allows for removal of the residual solution on the infused food pieces without the additional washing step by draining the infusion solution from the apparatus under vacuum. The pieces are then removed from the apparatus and sugar buildup in downstream operations is decreased.

The invention also allows for the steps of tempering individually quick frozen food pieces and infusion to be accomplished within a single apparatus. The pieces may be tempered while in the apparatus by circulating the infusion solution at a higher temperature to gradually increase the pieces' temperature. As the pieces thaw, infusion begins, which decreases the overall time needed for the infusion process.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself however, as well as a preferred mode of use, further objectives and advantages thereof, will be best understood by reference to the following detailed description of illustrative embodiments when read in conjunction with the accompanying drawings, wherein:

FIG. 1 is a flow chart representation depicting a preferred embodiment of the method of Applicants' invention;

FIGS. 2A and 2B are schematic side view representations of a first embodiment of Applicants' invention;

FIG. 2C is a partial top perspective view representation of a first embodiment of Applicants' invention;

FIGS. 3A and 3B are schematic side view representations of a second embodiment of Applicants' invention; and

FIG. 3C is a partial top perspective view representation of a second embodiment of Applicants' invention.

### DETAILED DESCRIPTION

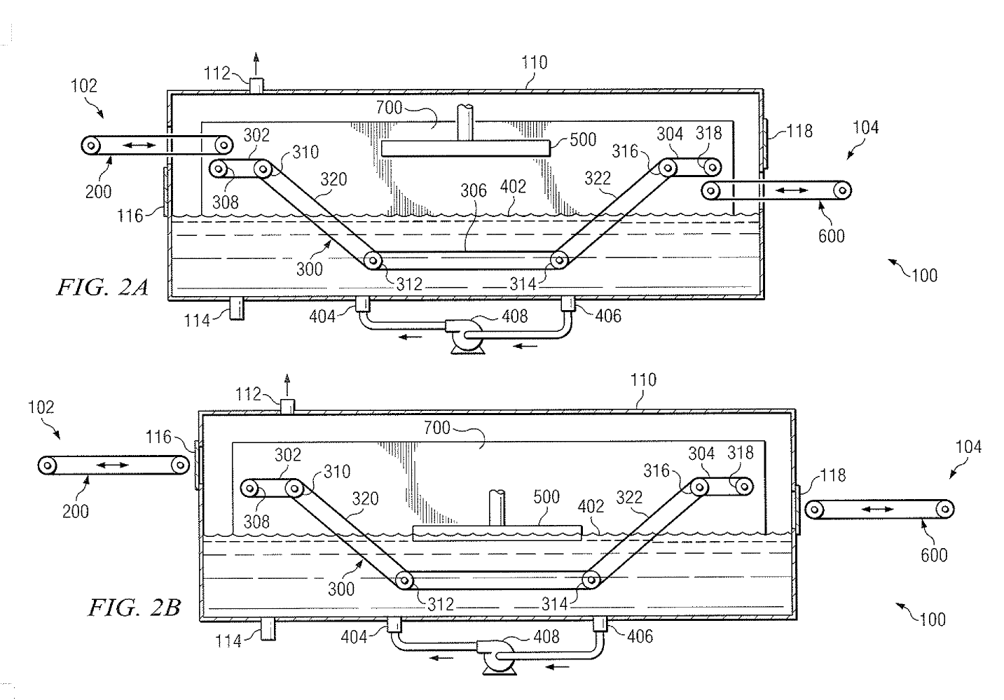

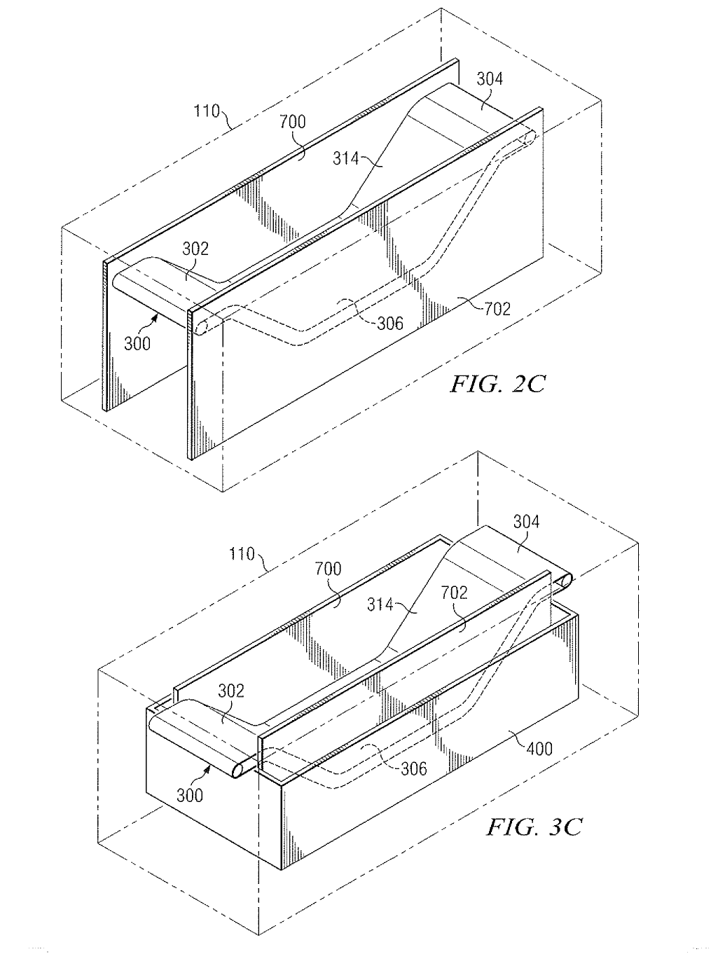

With reference to the accompanying drawings, identical reference numerals will be used to identify identical elements throughout all of the drawings. In the absence of an indication to a specific figure, refer to FIG. 2A.

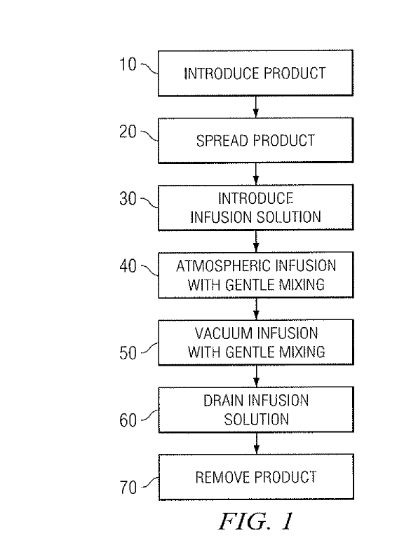

A preferred embodiment of the method of the invention is shown in FIG. 1. In the first step 10, food pieces (“product” or “pieces”) are introduced into the apparatus. The food pieces are preferably Emit or vegetable pieces, but also may include meats. The food pieces are spread out on a U-shaped conveyor within the apparatus to form a bed of product 20. An infusion solution is introduced into the apparatus 30 and the food pieces are soaked in the infusion solution at atmospheric pressure for a period of time 40. The apparatus is then depressurized, thus creating a vacuum therein, and the pieces are soaked in the infusion solution for an additional time 50. During the steps of atmospheric and vacuum infusion 40, 50, the product is periodically immersed in the infusion solution and gently mixed. After infusion is complete, the infusion solution is drained from the apparatus, first at atmospheric pressure and then under a slight vacuum to remove residual infusion solution on the pieces 60. Finally, the infused product is removed from the apparatus and taken for further operations 70. Details of the above method will be further understood with reference to the following paragraphs and in conjunction with the described apparatus.

Using the method and apparatus of the present invention, food pieces may undergo atmospheric, vacuum, or hybrid infusion depending on the specific product needs. Hybrid infusion comprises an atmospheric infusion phase and a vacuum infusion phase to achieve the most efficient infusion. The method illustrated in FIG. 1 describes a preferred method for hybrid infusion. The disclosed method may be readily modified to perform only atmospheric or vacuum infusion to achieve the desired product. To perform atmospheric infusion alone, the vacuum infusion step 50 may be omitted. To perform vacuum infusion alone, the atmospheric infusion step 40 may be omitted.

Prior to infusion, the food pieces may be fresh or individually quick frozen, depending on the desired product characteristics and availability. Examples of fruit pieces which may be used include, but are not limited to, apple pieces, pineapple cubes, sliced mango, sliced papaya, sliced jack fruit, canned Lychee, sliced pear, whole/sliced strawberry, whole blueberry, whole raspberry, and banana pieces. Examples of vegetable pieces which may be used include, but are not limited to, whole green beans, sliced carrots, whole cauliflower heads, whole broccoli heads with florets, sliced sweet potato, taro sticks, and sliced squash. The infusion solution can be custom designed to contain various mono, di, or oligo saccharides, fruit juices, or vegetable fibers to achieve the desired product characteristics.

In a preferred method of using the apparatus of Applicants' invention, the product is initially soaked in the infusion solution at atmospheric pressure, approximately 760 torr (1 atm), for 30 minutes to 4 hours, to allow replacement of a sufficient portion of the product's water content with infusion solutes. The structural integrity of the product is reinforced as it is filled with solids, which avoids collapse during frying in further operations. The infusion solution is maintained at a temperature at or below 50° F., more preferably in the range of 45° F. to 50° F., most preferably at 50° F., and a solute concentration of 43 brix to 45 brix, preferably about 45 brix. Maintaining the temperature at or below 50° F. is preferred to control microbial growth. A microbicide may also be added to the infusion solution to prevent or slow the growth of microbes, thereby allowing higher temperatures as well.

When the food pieces are individually quick frozen prior to being infused, the product must be tempered before infusion can occur. Applicants' apparatus allows for both tempering and infusing the product within the apparatus, thus eliminating the need for a separate piece of equipment to perform this operation. Referring to FIG. 1, the tempering step, if needed, occurs between the introduction of infusion solution 30 and the atmospheric infusion with gentle mixing 40. The temperature of the product rises as the infusion solution is circulated through the apparatus at a constant temperature of, for example 50° F. Typically, after 20 to 30 minutes, the individually frozen product is tempered to approximately 30° F. and begins to infuse 40. Combining the steps of tempering the product and infusion into a single vessel decreases the processing time and provides for more efficient infusion.

Fresh product does not require tempering prior to infusion. Upon immersion in the infusion solution, the product begins to take in solids. Thus, the time required to infuse by soaking at atmospheric pressure for fresh product is considerably less than that for an individually quick frozen product.

In a preferred method, the food pieces are first infused at atmospheric pressure, by soaking in the infusion solution at atmospheric pressure, for 30 minutes to 4 hours. Examples of the typical length of the atmospheric pressure phase for different fruits and vegetables undergoing hybrid infusion are about as follows: apple (fresh)—30 minutes; pineapple (individually quick frozen)—101 minutes; green bean (individually quick frozen)—60 minutes; and carrot (individually quick frozen)—60 minutes. These times can vary depending on the specific product and the desired end product attributes.

After the infusion phase at atmospheric pressure, the apparatus is depressurized through a vacuum port to a predetermined level, preferably in the range of 50 to 600 torr, more preferably in 100 to 500 torr, and most preferably in 200 to 400 torr, as needed and customized for the product being infused. Examples of the vacuum pressure typically used for various fruit and vegetable pieces under the hybrid infusion method are as follows: apple (fresh)—200 torr; pineapple (individually quick frozen)—400 torr; green bean (individually quick frozen)—400 torr; and carrot (individually quick frozen)—200 torr. These pressures are, however, provided for the purpose of illustration and are not limitations. The vacuum may be maintained for 5 minutes to 1 hour. Again, the residence time and pressures involved in the step can vary significantly depending on the product and desired end product.

In a preferred embodiment of the invention, pulses of vacuum are used to further accelerate the solute intake. A pulse of vacuum comprises depressurizing the apparatus for a short period of time and then repressurizing. Each pulse of vacuum is typically maintained for 2 minutes. Applying at least one pulse, and up to three pulses, of vacuum results in the most efficient product infusion.

In the hybrid infusion method, vacuum infusion is preferably performed after a time of infusion at atmospheric pressure in order to protect the product's cell walls. Applying vacuum before the product has been infused to some degree damages the cell walls of the product, leading to increased oil absorption during farther processing. Therefore, strengthening the product from solute build-up during the atmospheric phase and then subjecting the product to vacuum infusion allows for a stronger product in a shorter overall time. A period of vacuum infusion following the atmospheric infusion phase is preferred in order to infuse the product with solids more efficiently. Upon the depressurization, gas contained between the cell walls of the product is evacuated. When the vacuum is released, repressurization causes the product to take in solids from the infusion solution to fill the spaces gas previously occupied.

Once infusion is complete, the infusion solution is drained from the apparatus. A vacuum may be applied during draining, preferably after the bulk of the solution has been removed and the product has settled onto the U-shaped conveyor. In a preferred embodiment, the pressure of the apparatus is lowered, for example, to about 400-600 torr, through a vacuum port for a brief period of time, for example, about 2-5 minutes. This brief period of gentle vacuum allows for the removal of any excess solution on the surface of the product, resulting in decreased sugar buildup in the downstream dehydration operations. The product is then removed from the apparatus for downstream operations.

An apparatus for the atmospheric, vacuum, or hybrid infusion of food pieces in accordance with one embodiment of the invention is shown in FIG. 2A. An infusion vessel 100 receives the food pieces to be infused at an entrance area 102. After infusion, the pieces exit the vessel 100 at an exit area 104. Between the entrance area 102 and the exit area 104 is an enclosure 110 having a port 112 for controlling the pressure of the enclosure and a sump drain 114, thus the enclosure 110 is a sealable vessel. The enclosure 110 is, in a preferred embodiment, constructed of a stainless steel rectangular box. Stainless steel is preferred as the construction material to avoid infusion solution quality issues after caustic cleaning. However, other shapes may be used for the enclosure 110, for example, a cylindrically shaped enclosure.

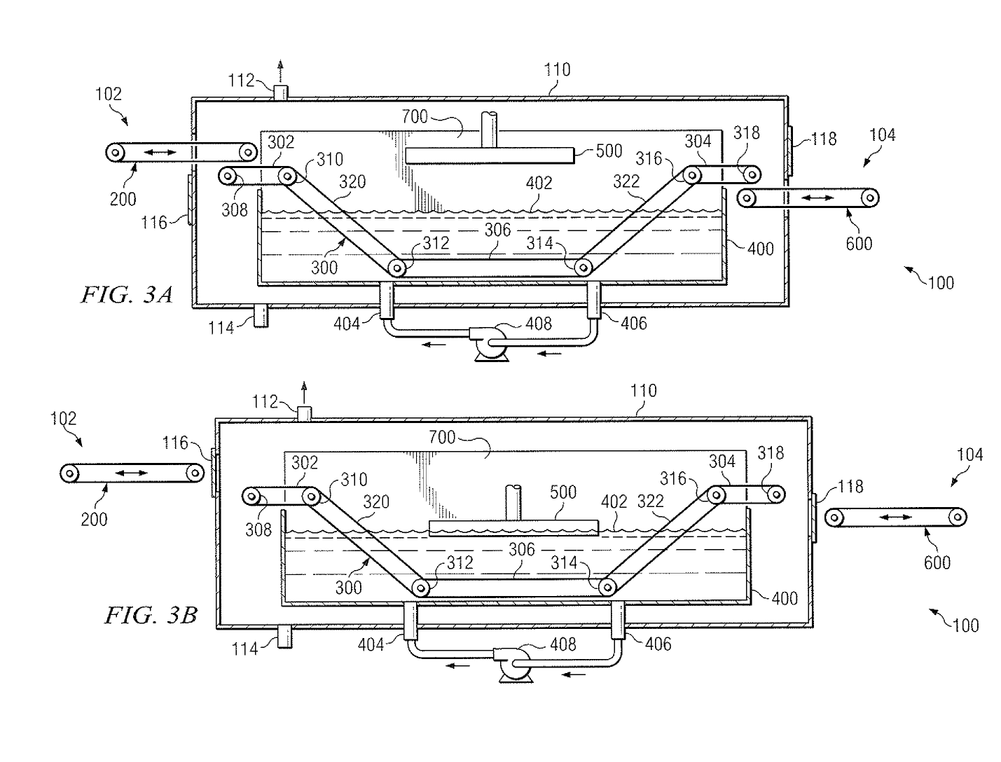

In two different preferred embodiments of the invention, as shown in FIGS. 2A and 3A, the entrance area 102 comprises a sealable entrance door 116 and a retractable inlet conveyor 200, which receives fresh product or product from a previous unit operation. The entrance door 116 is positioned directly above the receiving raised end 302 of an internal U-shaped conveyor 300. To introduce product into the vessel 100, the entrance door 116 opens to allow the retractable inlet conveyor 200 to enter the vessel 100. The product proceeds along the retractable inlet conveyor 200, where it is discharged and received by the U-shaped conveyor 300 at or near the receiving raised end 302.

The internal U-shaped conveyor 300 has opposed raised ends 302, 304 that form a trough 306 between the raised ends 302, 304. The U-shaped conveyor 300 is preferably made of meshed material, but may also be comprised of plastic or stainless steel roller chains positioned side by side, stainless steel woven mesh, plastic interlocking belting, or any other material that allows fluid to freely pass through the conveyor 300. The U-shaped conveyor 300 is supported and conducted by rollers. As an example, six rollers 308, 310, 312, 314, 316, 318 are shown in the drawings; however, fewer or additional rollers may be required in order to maintain the desired shape of the conveyor 300. The number of rollers and their placement will be known to those skilled in the art. The food pieces are deposited from the retractable inlet conveyor 200 onto the moving U-shaped conveyor 300 at receiving raised end 302. The pieces then proceed down the incline 320 of the U-shaped conveyor 300 to form a product bed in the trough area 306. The U-shaped conveyor 300 stops once the product has been spread out on the trough 306 and before it exits the U-shaped conveyor 300 at the discharging raised end 304.

After the desired amount of product has been introduced into the vessel 100, the retractable inlet conveyor 200 is removed from the vessel 100. The entrance door 116 is then tightly closed so that the vessel 100 is sealed from the external environment, thereby allowing for depressurization of the vessel. Other possible methods for introducing food pieces into the vessel 100 are, for example, by stationary inlet conveyor or rotary airlock.

Referring to FIG. 2B, an infusion solution 402 is introduced into the vessel 100 by an inlet fluid port 404 such that the product bed on the trough 306 is completely immersed in the infusion solution 402. If the introduced pieces are buoyant in the solution, care must be taken that the level of the infusion solution 402 does not exceed the inclined sections 320, 322 of the U-shaped conveyor 300. If the level of the infusion solution 402 rises above the inclined sections 320, 322 of the U-shaped conveyor 300, the product can flow beyond the U-shaped conveyor 300 and present collection and cleaning issues.

In an alternate embodiment of the invention, as shown in FIG. 3A, the vessel 100 comprises an internal basin 400 to hold the infusion solution 402. The trough 306 of the U-shaped conveyor 300 is positioned in the basin 400 in such a way that the trough 306 is below the fill line of the basin while the raised ends 302, 304 extend past the fill line. The basin is filled with an infusion solution 402 by an inlet fluid port 404 such that the product bed on the trough 306 is completely immersed in the infusion solution 402. Again, care must be taken that the level of the infusion solution 402 does not exceed the fill line of the basin 400; otherwise the product can flow beyond the U-shaped conveyor 300 and present collection and cleaning issues.

In a preferred embodiment, the food pieces are subjected to atmospheric and vacuum infusion phases. The infusion solution 402 during the total residence of the product in the apparatus is maintained in the range of about 45° F. to 50° F., preferably at about 50° F., and a solute concentration of about 43 brix to 45 brix, preferably about 45 brix is also maintained. Maintenance of the desired temperature and concentration is accomplished by circulating the infusion solution 402 through an external system 408 that is in fluid communication with the vessel 100 by the inlet fluid port 404 and the outlet or exit fluid port 406, as shown in two different embodiments of the invention in FIGS. 2A and 3A. The external system 408, in a preferred embodiment, comprises a pump, a fluid reservoir with an increased capacity to hold drained fluid, at least one heat exchanger which maintains the desired solution temperature, and a filtration element that filters the large food particulates from the solution before it is returned to the vessel 100 via the inlet fluid port 404. The external system can utilize a single heat exchanger that has both heating and cooling capabilities or two separate heat exchangers, one for cooling and one for heating.

Draining and replacement of the fluid through the external system 408 is possible while the vessel 100 is at atmospheric pressure or under vacuum. Although not shown in the figures, a preferred embodiment of Applicants' apparatus uses a distribution pipe to route the inlet port 404 to a position above the trough 306 and the product bed for distribution of solution onto the top of the product bed by, for example, spray balls or spray nozzles. This introduction of the solution above the product bed assists with the agitation of the product bed, helps with product immersion, and provides a convenient means for cleaning the mixing mechanism. Thus, the preferred embodiment places the inlet port 404 above the trough 306.

Throughout the atmospheric and vacuum infusion phases, a mixing mechanism 500, positioned directly above the trough 306, is intermittingly lowered into the product bed. In a preferred embodiment, the mixing mechanism is a rectangular slab, but may be modified by those skilled in the art. By way of example, the rectangular slab of the mixing mechanism 500 may be constructed of constructed of stainless steel, TEFLON™ (polytetrafluoroethylene), ultra-high molecular weight polyethylene (UHMW), nylon, or other suitable materials known in the art. As shown in FIGS. 2B and 3B with two different embodiments of the invention, the mixing mechanism 500 gently immerses any product that is floating in the infusion solution 402 and agitates the product that is immersed. The mixing mechanism 500 is automated and may be operated via a cam to be lowered into the product bed at a predetermined but adjustable velocity and periodicity, customized for the product being infused, but typically in a range of between about once per minute to about once per fifteen minutes. The mixing mechanism moves upwardly and downwardly above the trough 306 to immerse and agitate the food pieces in the solution. It can also be said that the mixing mechanism is moved into and out of the product bed. Mixing the product in this way ensures sufficient contact between the product and the infusion solution 402 so that each piece of product is infused with the desired amount of infusion solids to prevent collapse during further operations.

The retaining walls 700, 702, preferably constructed of stainless steel, abut with and are aligned longitudinally with the elongated sides of the U-shaped conveyor 300 and extend its entire length above the solution fill line in a preferred embodiment of the invention, as shown in FIGS. 2C and 3C. In an alternate embodiment, the retaining walls 700, 702 may be multiple individual steel segments that are integral to the belting of the U-shaped conveyor 300 and move as the conveyor moves. In another embodiment, the enclosure 10 may be constructed so that the width of the enclosure 110 is the width of the internal U-shaped conveyor 300 such that the side walls of the enclosure 110 act as the retaining walls 700, 702. In another embodiment, the basin 400 may be constructed so that the width of the basin 400 is the width of the internal U-shaped conveyor 300 such that the side walls of the basin 400 act as the retaining walls 700, 702. During infusion, the retaining walls 700, 702 prevent floating food pieces from migrating away from above the U-shaped conveyor 300, thereby maintaining a product bed on the U-shaped conveyor 300.

When infusion is complete, the infusion solution 402 is drained from the vessel 100 through the outlet fluid port 406. As the infusion solution 402 drains, gravity causes the infused food pieces, floating or immersed in the solution, to settle on the trough 306 of the U-shaped conveyor 300. The retaining walls 700, 702 further ensure that the product will settle on the trough 306 as the product has no other direction to go. In a preferred embodiment, once the pieces have settled onto the trough 306, a brief period of vacuum is applied to remove any excess solution from the surface of the product.

Returning to FIG. 2A, the U-shaped conveyor 300, which now holds a bed of infused product, starts again and moves the product up the incline 322 to the raised end 304, where the product is discharged at the exit area 104.

In two preferred embodiments of the invention, as shown in FIGS. 2A and 3A, the exit area 104 comprises a sealable exit door 118 and a retractable exit conveyor 600. The exit door 118 is positioned directly below the discharging raised end 304 of the U-shaped conveyor 300. For removal of the infused food pieces from the vessel 100, the exit door 118 opens to allow the retractable exit conveyor 600 to enter the vessel 100. As the product proceeds along the U-shaped conveyor 300 and reaches the discharging raised end 304, the product is transferred to the retractable exit conveyor 600. The retractable exit conveyor 600 carries the product for further operations, which may comprise vacuum frying, atmospheric frying, vacuum drying, vacuum microwave drying, or any other dehydration operation as known in the art. When all of the infused product has been removed from the vessel 100, the retractable exit conveyor 600 is removed from the vessel 100. The exit door 118 is then tightly closed so that the vessel 100 is sealed from the external environment, thereby allowing for depressurization of the vessel. Other possible methods for removing infused product from the vessel 100 are by stationary conveyor or rotary airlock.

The hybrid infusion of food pieces in the apparatus of the proposed invention allows for the removal of 10.0-15.0% of the moisture content of the pieces and the addition of 10.0-15.0% of solids. The following tables exemplify the results obtained under the process conditions as set forth above.

TABLE 1
Apple conditions prior to infusion.

| Parameter | Measure Unit | Aim | Range |
|---|---|---|---|
| Raw apple slice | inch | 0.138 | 0.13-0.15 |
| thickness | | | |
| Raw apple moisture | % wet basis | 88.0 | 85.0-90.0 |
| content | | | |
| Raw apple solids | % wet basis | 12.0 | 10.0-15.0 |
| Apple slice | ° F. | 48 | 45-60 |
| temperature | | | |

TABLE 2
Apple conditions after infusion with corn syrup as the infusion solution.

| Parameter | Measure Unit | Aim | Range |
|---|---|---|---|
| Moisture content of | % | 75.0 | 73.0-77.0 |
| infused apple pieces | | | |
| Total solids of | % | 25.0 | 23.0-27.0 |
| infused apple pieces | | | |
| Corn syrup solids in | % | 12 | 10-14 |
| infused apple pieces | | | |

TABLE 3
Pineapple conditions prior to infusion.

| Parameter | Measure Unit | Aim | Range |
|---|---|---|---|
| Pineapple (IQF) | mm | 9 | 8-10 |
| chunk thickness | | | |
| External are width | mm | 27 | 24-30 |
| Pineapple chunk | mm | 30 | 25-35 |
| length | | | |
| Pineapple (IQF) | % wet basis | 85.5 | 84.0-88.0 |
| moisture content | | | |
| Pineapple (IQF) | % wet basis | 14.5 | 12.0-16.0 |
| solids | | | |
| Temperature of | ° F. | −10 | −10-10 |
| pineapple (IQF) | | | |
| chunks | | | |

TABLE 4
Pineapple conditions after infusion
with corn syrup as the infusion solution.

| Parameter | Measure Unit | Aim | Range |
|---|---|---|---|
| Moisture content of | % | 75.0 | 73.0-77.0 |
| infused pineapple | | | |
| pieces | | | |
| Total solids of | % | 25.0 | 23.0-27.0 |
| infused pineapple | | | |
| pieces | | | |
| Corn syrup solids in | % | 12 | 10-14 |
| infused pineapple | | | |
| pieces | | | |

The apparatus may be easily cleaned in-place using methodologies well developed in the food industry.

The above described invention discloses a method and preferred embodiments of an apparatus for the hybrid infusion of food pieces. Although the invention has been particularly shown and described, the disclosure is not intended to limit the scope of the invention. It will be understood by those skilled in the art that various changes in form and conditions may be made therein without departing from the spirit and scope of the invention.

What is claimed is:

1. An apparatus for the infusion of food pieces comprising:
a sealable vessel;
a conveyor within said vessel, wherein said conveyor comprises opposed raised ends that form a trough between said raised ends;
a mixing mechanism contained within said vessel and positioned directly above said trough;
a vacuum port; and
at least one fluid port for the introduction of a solution into said vessel.

2. The apparatus of claim 1 wherein said mixing mechanism moves upwardly and downwardly above said trough to immerse and agitate said food pieces in said solution.

3. The apparatus of claim 1 wherein said mixing mechanism is automated to move upwardly and downwardly above said trough.

4. The apparatus of claim 3 wherein the automated velocity and periodicity of said mixing mechanism is adjustable.

5. The apparatus of claim 1 wherein said apparatus comprises an inlet fluid port and an outlet fluid port.

6. The apparatus of claim 5 wherein said inlet fluid port is located above the trough.

7. The apparatus of claim 1 further comprising a fluid reservoir wherein said reservoir is located outside of said apparatus and is in fluid communication with said apparatus.

8. The apparatus of claim 7 wherein said fluid reservoir further comprises at least one heat exchanger.

9. The apparatus of claim 7 wherein said fluid reservoir further comprises a filtration element.

10. The apparatus of claim 7 wherein said fluid reservoir further comprises a pump.

11. The apparatus of claim 1 further comprising two retaining walls aligned longitudinally with the elongated sides of said conveyor and extending above a fill line within said apparatus.

12. The apparatus of claim 1 further comprising a sealable entrance door.

13. The apparatus of claim 12 wherein said entrance door is positioned above the receiving end of said conveyor.

14. The apparatus of claim 1 further comprising a sealable exit door.

15. The apparatus of claim 14 wherein said exit door is positioned below the discharging end of said conveyor.

16. The apparatus of claim 1 further comprising a sump drain.

17. An enclosed apparatus for the infusion of food pieces comprising:
a conveyor located within said apparatus and having raised ends that form a trough between said raised ends;
a mixing mechanism located within said apparatus and positioned above said trough; and
wherein said apparatus is sealable and in fluid communication with a fluid reservoir located outside said apparatus.

18. The apparatus of claim 17 wherein said mixing mechanism moves upwardly and downwardly above said trough to agitate and immerse said food pieces in a solution.

19. The apparatus of claim 17 wherein said mixing mechanism is automated to move upwardly and downwardly above said trough.

20. The apparatus of claim 19 wherein the automated velocity and periodicity of said mixing mechanism is adjustable.

21. The apparatus of claim 17 further comprising an inlet port and an outlet port.

22. The apparatus of claim 21 wherein said inlet fluid port is located above said trough.

23. The apparatus of claim 17 further comprising a fluid reservoir wherein said reservoir is located outside of said apparatus and is in fluid communication with said apparatus.

24. The apparatus of claim 23 wherein said fluid reservoir further comprises at least one heat exchanger.

25. The apparatus of claim 23 wherein said fluid reservoir further comprises a filtration element.

26. The apparatus of claim 23 wherein the fluid reservoir further comprises a pump.

27. The apparatus of claim 17 further comprising a vacuum port.

28. The apparatus of claim 17 further comprising two retaining walls aligned longitudinally with the elongated sides of said conveyor and extending above a fill line within said apparatus.

29. The apparatus of claim 17 further comprising a sealable entrance door.

30. The apparatus of claim 29 wherein said entrance door is positioned above the receiving end of said conveyor.

31. The apparatus of claim 17 further comprising a sealable exit door.

32. The apparatus of claim 31 wherein said exit door is positioned below the discharging end of said conveyor.

33. The apparatus of claim 17 further comprising a sump drain.

34. A method for the infusion of food pieces within an enclosed apparatus, said apparatus comprising a conveyor located within said apparatus with raised ends that form a trough between said raised ends, a mixing mechanism that is automated to move upwardly and downwardly above said trough at a predetermined velocity and periodicity, and a vacuum port, said method comprising the steps of:
(a) introducing food pieces into the apparatus;
(b) spreading said food pieces on the trough formed by the conveyor, thus forming a product bed;
(c) introducing an infusion solution into said apparatus such that said product bed is immersed in said infusion solution;
(d) agitating said food pieces while in said infusion solution by moving said mixing mechanism into and out of said product bed;
(e) soaking said food pieces in said infusion solution at atmospheric pressure;
(f) depressurizing said apparatus via said vacuum port for a predetermined amount of time;
(g) draining said infusion solution from said apparatus such that said product is deposited on said trough; and
(h) removing said product from said apparatus.

35. The method of claim 34 wherein step (a) further comprises introduction of said food pieces onto said conveyor in said apparatus by a retractable inlet conveyor.

36. The method of claim 34 wherein step (h) further comprises removing said product from said apparatus by a retractable exit conveyor.

37. The method of claim 34 wherein step (c) further comprises introducing said infusion solution into said apparatus by an inlet fluid port.

38. The method of claim 34 wherein step (g) further comprises draining said infusion solution from said apparatus by an exit fluid port.

39. The method of claim 34 further comprising the step of tempering said product prior to step e).

40. The method of claim 34 wherein said infusion solution is maintained at a temperature of about 45° F. to about 50° F.

41. The method of claim 34 wherein said infusion solution is maintained at a concentration of about 43 brix to about 45 brix.

42. The method of claim 34 wherein said infusion solution is circulated through an external system to maintain a temperature of between about 45° F. to about 50° F. and a solute concentration of about 43 brix to about 45 brix.

43. The method of claim 34 wherein step (f) further comprises depressurizing said apparatus to between about 50 torr to about 600 torr.

44. The method of claim 34 wherein step (f) further comprises pulses of vacuum.

45. The method of claim 44 wherein 1 to 3 said pulses of vacuum are used.

46. The method of claim 44 wherein said pulses of vacuum persist for about 2 minutes.

47. The method of claim 34 further comprising the step of depressurizing said apparatus via said vacuum port for a predetermined amount of time to remove excess solution from said product after step (g) and prior to step (h).

48. The method of claim 47 wherein said apparatus is depressurized to between about 400 torr to about 600 torr.

49. The method of claim 34 wherein the predetermined time of step (f) is about 2 minutes to about 5 minutes.

50. The method of claim 34 wherein said infusion solution contains a microbicide to control microbe growth.

51. An infused food product made by the method of claim 34.
